(19) United States
(12) Patent Application Publication
(10) Pub. No.: US 2010/0103586 A1
(43) Pub. Date: Apr. 29, 2010

(54) MULTILAYER CERAMIC CAPACITOR

(75) Inventors: Jing-Rong Tang, Taipei City (TW); Hui-Bang Yeh, Taipei City (TW); J. H. Chen, Taipei City (TW); Hun-Ming Wang, Taipei City (TW); Joseph Ling, Taipei City (TW); Brian Chen, Taipei City (TW)

Correspondence Address: HOLY STONE ENTERPRISE CO., LTD., P.O.BOX 108-00403, Taipei, 106, omitted

(73) Assignee: HOLY STONE ENTERPRISE CO., LTD., Taipei City (TW)

(21) Appl. No.: 12/259,301

(22) Filed: Oct. 28, 2008

(51) Int. Cl. H01G 4/005

(52) U.S. Cl. 361/301.4

(57) ABSTRACT

A multilayer ceramic capacitor includes a rectangular dielectric body having ceramic layers and multiple first internal electrodes and second internal electrodes alternatively arranged in between each two adjacent ceramic layers and respectively terminating in a respective contact in such a manner that the contacts of the first internal electrodes and the contacts of the second internal electrodes are respectively disposed at two diagonal corners of the dielectric body, and multiple terminal electrodes respectively bonded to the two diagonal corners of the dielectric body and respectively electrically connected with the contacts of the first internal electrodes and the contacts of the second internal electrodes. By means of arranging the terminal electrodes on the two diagonal corners to extend the electrode pitch, the multilayer ceramic capacitor prevents an electric arc effect or electrical fire caused by a surge voltage, eliminating the risk of a short circuit or other accidental events.

### BACKGROUND OF THE INVENTION

1. Field of the Invention

The present invention relates to a multilayer ceramic capacitor and more particularly, to such a multilayer ceramic capacitor that has the terminal electrodes arranged on two diagonal corners of the dielectric body to extend the electrode pitch, preventing an electric arc effect or electrical fire caused by a surge voltage and eliminating the risk of a short circuit or other accidental events.

2. Description of the Related Art

Regular electronic products commonly use many active and passive components. An active component (such as IC or CPU) is a device that adds intelligence in some manner to the signal or data that passes through it. A passive component is device that does not have any impact on the electrical signals or the data that passes through it. Resistor, capacitor and inductor are the three major passive components. Functionally, a capacitor is an electronic device that stores a charge of static electricity and, when properly stimulated, releases this charge. This is the way bits are written to and read from computer storage. A resistor is the component of an electrical circuit that produces head while offering opposition, or resistance, to the flow of electric current. Further, an inductor is a passive electrical component with significant inductance and adapted for removing noises from electric current passing therethrough to avoid electromagnetic interference. Resistor, capacitor and inductor are used together in information, communication and consumer electronics products and other industrial products for electronic loop control.

Further, passive components are developed toward chip fabrication. Following the development tendency of integrated circuits toward high performance and high density and the creation of SMT (surface mounting technology), electronic devices of SMT chip designs are intensively used to substitute for through hole designs. In consequence, the demand for passive components that are made in a chip form rises rapidly, and the requirement for a relatively smaller size is more and more strong

A capacitor stores static electricity in the electric field between a pair of conductors (called “plates”) that are isolated from each other by a thin layer of dielectric material, thereby achieving charge storing, by-passing, filtering, tuning and osscilating functions. Further, capacitors can be classified, subject to their materials, as aluminum electrolytic capacitors, ceramic capacitors, metallized plastic thin film capacitors, tantalium capacitors and mica capacitors. Further, capacitors are classified to be fixed capacitors, variable capacitors or chip capacitors subject to the dielectric material used.

Further, ceramic capacitors include single layer ceramic capacitors and multilayer ceramic capacitors (MLCC). When compared to other low value capacitor types, multilayer ceramic capacitors have the advantages of high dielectric coefficient, excellent insulation, excellent voltage and heat resistance, high capacity, small size, high reliability, high working temperature range. Further, multilayer ceramic capacitors are suitable for mass production at low price. Further, multilayer ceramic capacitors can be directly bonded to a circuit board by means of SMT (surface mounting technology). Nowadays, multilayer ceramic capacitors have become the market main steam and, are intensively used in small-sized multifunctional electronic products.

Further, a multilayer ceramic capacitor is a capacitor constructed of alternating layers of metal and ceramic, with the ceramic material acting as the dielectric, i.e., one ceramic layer is sandwiched between two parallel electrode layers to constitute a flat capacitor and the, and then the internal electrode layers are bonded to terminal electrodes to have the flat capacitors be connected in parallel. When flat capacitors are connected in parallel, V=V1=V2=V3= . . . =Vi, Q=C*V, and therefore, C=C1+C2+C3+ . . . +Ci. Thus, the total capacity of a multilayer ceramic capacitor is the sum of the capaicity of all the flat capacitors thereof, and connecting the flat capacitors in parallel achieves increase of the capacity or the energy storage effect.

FIG. 6 illustrates a multilayer ceramic capacitor according to the prior art. According to this design, the multilayer ceramic capacitor comprises a dielectric body A made in the shape of a rectangular block formed of multiple ceramic layers A1, first internal electrodes A2 and second internal electrodes A3 that are alternatively arranged in a stack with each ceramic layer Al sandwiched between one first internal electrode A2 and one second internal electrode A3, and two terminal electrodes B formed on two opposite ends of the dielectric body A and respectively electrically connected with the first internal electrodes A2 and the second internal electrodes A3. Further, for a high voltage output, an electronic apparatus usually uses a high-frequency transformer for driving. Further, to meet the design requirements for electronic products having light, thin, small and short characteristics, the aforesaid prior art multilayer ceramic capacitor must be small-sized, shortening the electrode pitch d2 between the two terminal electrodes B. However, shortening the electrode pitch tends to a surge voltage that may causes an electric arc effect or electrical fire, resulting in a short circuit.

Therefore, it is desirable to provide a multilayer ceramic capacitor that extends the electrode pitch without changing or extending the designed capacitor size, avoiding the aforesaid problem.

### SUMMARY OF THE INVENTION

The present invention has been accomplished under the circumstances in view. It is one object of the present invention to provide a multilayer ceramic capacitor, which prevents an electric arc effect or electrical fire caused by a surge voltage, thereby eliminating the risk of a short circuit or other accidental events.

To achieve this and other objects of the present invention, the multilayer ceramic capacitor comprises a rectangular dielectric body having ceramic layers and multiple first internal electrodes and second internal electrodes alternatively arranged in between each two adjacent ceramic layers and respectively terminating in a respective contact in such a manner that the contacts of the first internal electrodes and the contacts of the second internal electrodes are respectively disposed at two diagonal corners of the dielectric body, and multiple terminal electrodes respectively bonded to the two diagonal corners of the dielectric body and respectively electrically connected with the contacts of the first internal electrodes and the contacts of the second internal electrodes.

### BRIEF DESCRIPTION OF THE DRAWINGS

FIG. 1 is an elevational view of a multilayer ceramic capacitor in accordance with the present invention.

FIG. 2 is a sectional top view of the multilayer ceramic capacitor in accordance with the present invention.

FIG. 3 is another sectional top view of the multilayer ceramic capacitor in accordance with the present invention.

FIG. 4 is a sectional side view of the multilayer ceramic capacitor in accordance with the present invention.

FIG. 5 illustrates an application example of the present invention.

FIG. 6 is a perspective view of a multilayer ceramic capacitor in accordance with the present invention.

### DETAILED DESCRIPTION OF THE PREFERRED EMBODIMENT

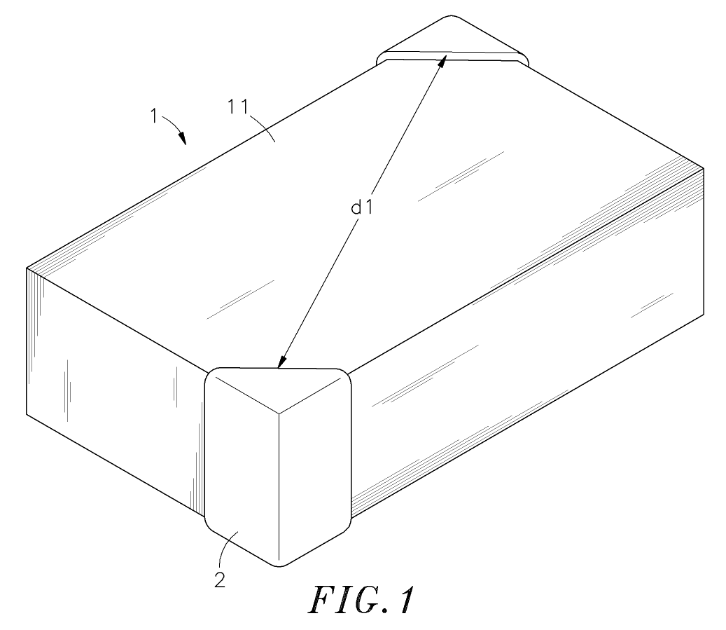

Referring to FIGS. 1˜5, a multilayer ceramic capacitor in accordance with the present invention is shown comprising a dielectric body 1 and a plurality of terminal electrodes 2.

The dielectric body 1 comprises multiple ceramic layers 11 and a plurality of first internal electrodes 12 and second internal electrodes 13 alternatively arranged in between each two adjacent ceramic layers 11 at different elevations and respectively terminating in a respective contact 121 or 131. The contacts 121 of the first internal electrodes 12 and the contacts 131 of the second internal electrodes 13 are respectively disposed in two diagonal corners relative to the ceramic layers 11.

The terminal electrodes 2 are respectively bonded to two diagonal corners of the dielectric body 1 corresponding to the contacts 121 of the first internal electrodes 12 and the contacts 131 of the second internal electrodes 13 and respectively electrically connected with the contacts 121 of the first internal electrodes 12 and the contacts 131 of the second internal electrodes 13.

After construction of the ceramic capacitor, the terminal electrodes 2 are respectively bonded to respective metal contacts 31 of a circuit board 3 by means of SMT (surface mounting technology) (see FIG. 5).

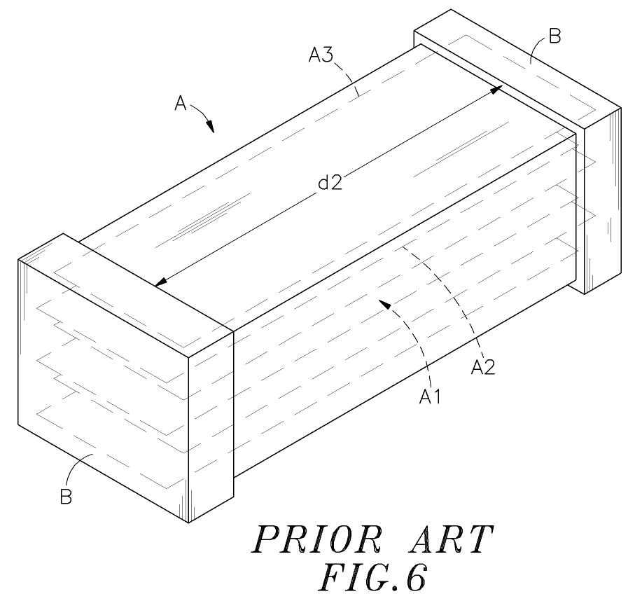

The fabrication of the multilayer ceramic capacitor includes the anterior brick fabrication process, an intermediate bulk fabrication process of binder burn out, dense sintering, termination dipping and termination curing steps, and a posterior fabrication process of termination plating, function testing and taping steps. This multilayer capacitor fabrication method is of the known art and not within the scope of the claims of the present invention. Therefore, no further detailed description in this regard is necessary. According to the present invention, a metal paste having high conductivity is selected and bonded to the contacts 121 of the first internal electrodes 12 and the contacts 131 of the second internal electrodes 13 under high temperature firing, thereby forming the desired two terminal electrodes 2 at two diagonal corners of the dielectric body 1. Thus, the diagonal pitch d1 between the two terminal electrodes 2 of the multilayer ceramic capacitor in accordance with the present invention (see FIG. 1) is greater than the linear pitch d2 between the two terminal electrodes B of a conventional multilayer ceramic capacitor having the same size (see FIG. 6). Further, the first internal electrodes 12 and the second internal electrodes 13 according to the present preferred embodiment are rectangular plate members. However, in actual application, the first internal electrodes 12 and the second internal electrodes 13 can be shaped like a circular or oval chip, or configured subject to any of a variety of shapes. Alternatively, the aforesaid first internal electrodes 12 and second internal electrodes 13 can be eliminated from the dielectric body 1, and multiple terminal electrodes 2 can be formed on at two diagonal corners of the dielectric body 1, maintaining the desired capacitor properties. Any multilayer ceramic capacitor fabrication method capable of making multilayer ceramic capacitors having the desired capacitive properties can be employed.

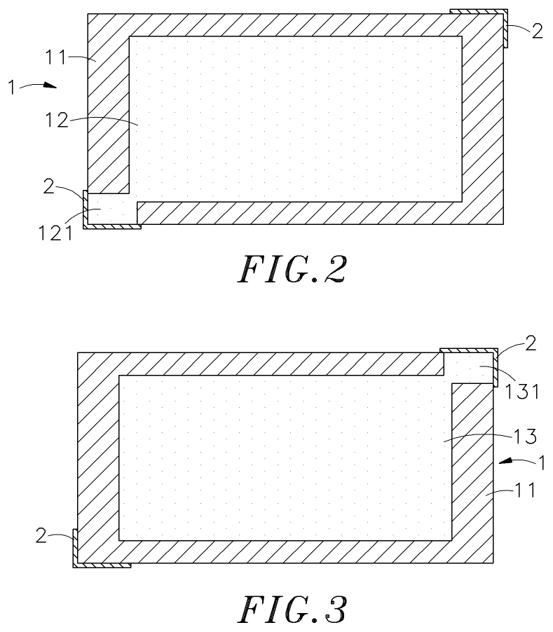

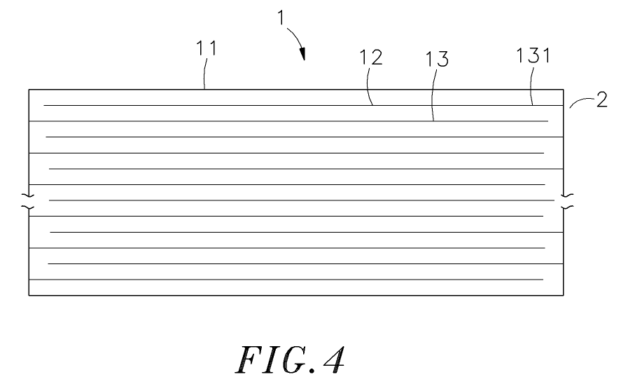

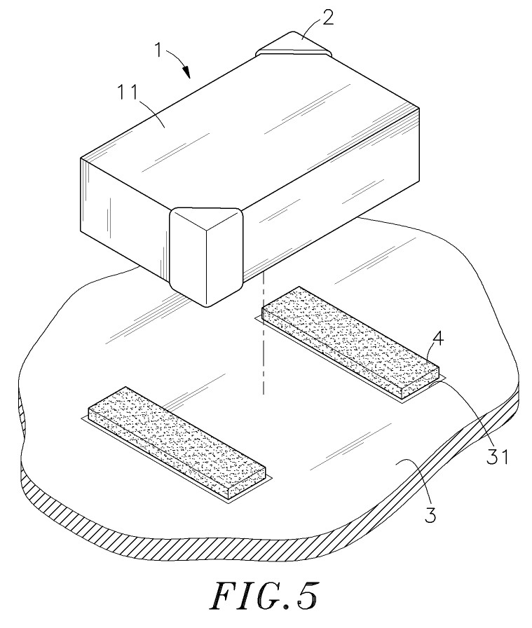

Referring to FIGS. 2, 3 and 5 again, the terminal electrodes 2 at two diagonal corners of the dielectric body 1 are covered with a layer of tin solder paste 4, and then respectively soldered to the metal contacts 31 of the circuit board 3 by means of SMT (surface mounting technology), providing the desired capacitive properties. After bonding, the device thus obtained is examined through a function test. In a multilayer ceramic capacitor constructed according to the prior art design, the short pitch between the two terminal electrodes tends to cause a surge voltage that may causes an electric arc effect or electrical fire, resulting in a short circuit. The invention eliminates this problem. By means of termination curing, a metal material is coated on the contacts 121 of the first internal electrodes 12 and the contacts 131 of the second internal electrodes 13, forming the desired two terminal electrodes 2 at two diagonal corners of the dielectric body 1. Pythagorean Theorem states that for a right-angled triangle the square of the hypotenuse c is equal to the sum of the squares on the two other sides a and b (c²=a²+b²).

When compared to the linear pitch d2 between the two terminal electrodes B of a multilayer ceramic capacitor according to the prior art (see FIG. 6), the invention increases the distance d1 between the two terminal electrodes 2 by means of forming the two terminal electrodes 2 on two diagonal corners of the dielectric body 1 (see FIG. 1) without changing or extending the designed capacitor size.

Therefore, the structural design of the multilayer ceramic capacitor according to the present invention prevents an electric arc effect or electrical fire caused by a surge voltage, eliminating the risk of a short circuit or other accidental events.

Referring to FIG. 1 again, 10 pcs multilayer ceramic capacitors of size, dielectric constant, capacitance and working voltage to be 2422/X7R/1000 pF/1 KV were prepared according to the present invention and 10 pcs multilayer ceramic capacitors of the same specifications prepared according to the prior art, and these multilayer ceramic capacitors were examined through a surge test (high voltage withstand and electrical fire prevention test). The data of the test results were indicated in the following Table I.

TABLE I

| | 2422/X7R/1000 pF/1 KV | | | | | |
|---|---|---|---|---|---|---|
| | MLCC of the prior art | | | MLCC of the invention | | |
| | | Number | | | Number | |
| | Surge | of times | Electrode | Surge | of times | Electrode |
| Item | test | passed | pitch | test | passed | pitch |
| 1 | 2.5 KV | 7 | 5.8 | 2.5 KV | >20 | 6.4 |
| 2 | 2.5 KV | 6 | 5.6 | 2.5 KV | >20 | 6.5 |
| 3 | 2.5 KV | 8 | 5.5 | 2.5 KV | >20 | 6.4 |
| 4 | 2.5 KV | 5 | 5.7 | 2.5 KV | >20 | 6.6 |
| 5 | 2.5 KV | 6 | 5.9 | 2.5 KV | >20 | 6.7 |
| 6 | 2.5 KV | 7 | 6.0 | 2.5 KV | >20 | 6.6 |
| 7 | 2.5 KV | 9 | 5.6 | 2.5 KV | >20 | 6.5 |
| 8 | 2.5 KV | 11 | 6.1 | 2.3 KV | >20 | 6.4 |
| 9 | 2.5 KV | 9 | 5.9 | 2.5 KV | >20 | 6.6 |
| 10 | 2.5 KV | 8 | 5.8 | 2.5 KV | >20 | 6.5 |
| Min. | | 5 | 5.5 | | 20 | 6.7 |
| Max. | | 11 | 6.7 | | 20 | 6.7 |
| Avg. | | | 5.8 | | 20 | |

From the left half of Table I, it can be seen that the electrode pitch d2 between the terminal electrodes B of the test samples according to the prior art (see FIG. 6) is within 5.7˜6.8 mm, and the related number of times passed through 2.5 KV surge test is 7˜8; from the right half of Table I, it can be seen that the electrode pitch d1 between the terminal electrodes 2 of the test samples according to the present invention (see FIG. 1) is within 6.5˜6.6 mm, and the related number of times passed through 2.5 KV surge test is over 20. As illustrated, the test data of the test samples prepared according to the present invention shows significant improvement over the test samples of the prior art design, meeting the requirements for “certificate of safety compliance”.

In conclusion, a multilayer ceramic capacitor in accordance with the present invention comprises a dielectric body 1, which comprises multiple ceramic layers 11 and a plurality of first internal electrodes 12 and second internal electrodes 13 alternatively arranged in between each two adjacent ceramic layers 11 at different elevations and respectively terminating in a respective contact 121 or 13, and two terminal electrodes 2 respectively electrically bonded to the contacts 121 of the first internal electrodes 12 and the contacts 131 of the second internal electrodes 13 at two diagonal corners of the dielectric body 1. By means of arranging the two terminal electrodes 2 on two diagonal corners of the dielectric body 1 to extend the electrode pitch, the invention prevents an electric arc effect or electrical fire caused by a surge voltage, eliminating the risk of a short circuit or other accidental events. Therefore, the invention greatly prolongs the capacitor service life.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A multilayer ceramic capacitor, comprising:
a dielectric body, said dielectric body comprising a plurality of ceramic layers arranged in a stack, and a plurality of first internal electrodes and second internal electrodes alternatively arranged in between each two adjacent ceramic layers at different elevations and respectively terminating in a respective contact; and
a plurality of terminal electrodes respectively bonded to two diagonal corners of said dielectric body and respectively electrically connected with the contacts of said first internal electrodes and the contacts of said second internal electrodes.

2. The multilayer ceramic capacitor as claimed in claim 1, wherein the contacts of said first internal electrodes and the contacts of said second internal electrodes are respectively disposed in said two diagonal corners of said dielectric body.

3. The multilayer ceramic capacitor as claimed in claim 2, wherein said terminal electrodes are respectively formed of a metal material and coated on the contacts of said first internal electrodes and the contacts of said second internal electrodes at said two diagonal corners of said dielectric body by means of terminating dipping and termination curing techniques.

4. The multilayer ceramic capacitor as claimed in claim 1, wherein said first electrodes and said second electrodes are rectangular chip-like electrodes.

5. The multilayer ceramic capacitor as claimed in claim 1, wherein said first electrodes and said second electrodes are circular chip-like electrodes.

6. The multilayer ceramic capacitor as claimed in claim 1, wherein said first electrodes and said second electrodes are oval chip-like electrodes.
